(19) United States
(12) Patent Application Publication
(10) Pub. No.: US 2026/0210239 A1
(43) Pub. Date: Jul. 23, 2026

(54) FIBER OPTICS CABLE

(71) Applicant: Schlumberger Technology Corporation, Sugar Land, TX (US)

(72) Inventors: Soon Seong CHEE, Sagamihara (JP); Masaei Ito, Sagamihara (JP); Takayuki KANNO, Sagamihara (JP)

(21) Appl. No.: 19/140,373

(22) PCT Filed: Jan. 26, 2024
(86) PCT No.: PCT/US2024/013035

§ 371 Date: Jun. 18, 2025

Related U.S. Application Data
(60) Provisional application No. 63/481,802, filed on Jan. 27, 2023.

(51) Int. Cl. E21B 47/135; E21B 47/007; E21B 47/07

(52) U.S. Cl. CPC E21B 47/135; E21B 47/007; E21B 47/07

(57) ABSTRACT

A method can include applying a carbon nanotubule coating to one or more components of a fiber optics cable assembly; deploying the fiber optics cable assembly in a downhole environment; and utilizing the fiber optics cable assembly in the downhole environment and a fiber optics cable assembly can include components, where the components include at least one optical fiber; and one or more carbon nanotubule coatings disposed on at least one of the components.

### CROSS-REFERENCE TO RELATED APPLICATION

This application claims priority to U.S. Provisional Patent Application No. 63/481802, filed on Jan. 27, 2023, which is incorporated by reference herein.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Various operations may be performed in the field to access such hydrocarbon fluids and/or produce such hydrocarbon fluids. For example, consider equipment operations where equipment may be controlled to perform one or more operations. In such an example, control may be based at least in part on characteristics of rock where drilling into such rock forms a borehole that can be completed to form a well to produce from a reservoir and/or to inject fluid into a reservoir. While hydrocarbon fluid reservoirs are mentioned as an example, a reservoir that includes water and brine may be assessed, for example, for one or more purposes such as, for example, carbon storage (e.g., sequestration), water production or storage, geothermal production or storage, metallic extraction from brine, etc.

### SUMMARY

A method can include applying a carbon nanotubule coating to one or more components of a fiber optics cable assembly; deploying the fiber optics cable assembly in a downhole environment; and utilizing the fiber optics cable assembly in the downhole environment and a fiber optics cable assembly can include components, where the components include at least one optical fiber; and one or more carbon nanotubule coatings disposed on at least one of the components. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates an example of a system;

FIG. 3 illustrates an example of a plot of fiber optics cable performance;

FIG. 4 illustrates examples of fiber optics cable deployments;

FIG. 5 illustrates examples of fiber optics cables;

FIG. 6 illustrates examples of fiber optics cables;

FIG. 7 illustrates an example of a method and an example of a system; and

FIG. 8 illustrates examples of computer and network equipment.

### DETAILED DESCRIPTION

This description is not to be taken in a limiting sense, but rather is made merely for the purpose of describing the general principles of the implementations. The scope of the described implementations should be ascertained with reference to the issued claims.

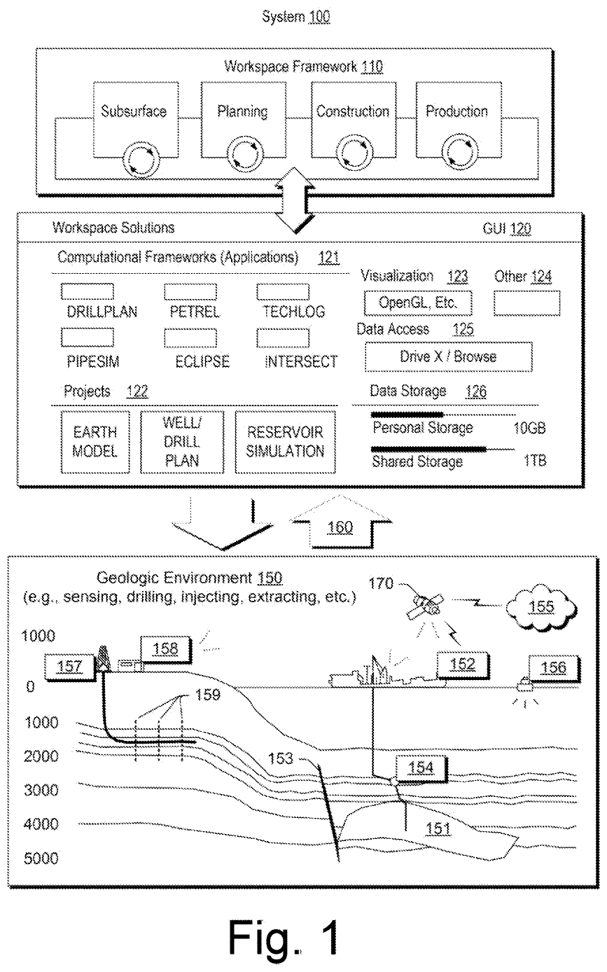

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. A geologic environment 150 may be outfitted with a variety of sensors, detectors, actuators, etc. In such an environment, various types of equipment such as, for example, equipment 152 may include communication circuitry to receive and to transmit information, optionally with respect to one or more networks 155. Such information may include information associated with downhole equipment 154, which may be equipment to acquire information, to assist with resource recovery, etc. Other equipment 156 may be located remote from a wellsite and include sensing, detecting, emitting, or other circuitry. Such equipment may include storage and communication circuitry to store and to communicate data, instructions, etc. One or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc., may exist where an assessment of such variations may assist with planning, operations, etc., to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). Such an environment can provide for operations that involve one or more frameworks. The DELFI environment may be referred to as the DELFI framework, which may be a framework of frameworks. The DELFI environment can include various other frameworks, which may operate using one or more types of models (e.g., simulation models, etc.).

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). The PIPESIM simulator may be an optimizer that can optimize one or more operational scenarios at least in part via simulation of physical phenomena.

The ECLIPSE framework provides a reservoir simulator with numerical solvers for prediction of dynamic behavior for various types of reservoirs and development schemes.

The INTERSECT framework provides a high-resolution reservoir simulator for simulation of geological features and quantification of uncertainties, for example, by creating production scenarios and, with the integration of precise models of the surface facilities and field operations, the INTERSECT framework can produce results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150, and feedback 160 can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

Visualization features may provide for visualization of various earth models, properties, etc., in one or more dimensions. As an example, visualization features may include one or more control features for control of equipment, which can include, for example, field equipment that can perform one or more field operations. A workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.). Field acquisition equipment may be utilized to acquire seismic data, which may be in the form of traces where a trace can include values organized with respect to time and/or depth (e.g., consider 1D, 2D, 3D or 4D seismic data).

A model may be a simulated version of a geologic environment where a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. While several simulators are illustrated in the example of FIG. 1, one or more other simulators may be utilized, additionally or alternatively.

Various types of services may be deployed at a field site to acquire various types of data. For example, consider a logging-while-drilling (LWD) service and/or a measurement-while-drilling (MWD) service that utilize one or more tools as part of a drillstring for drilling a borehole. As another example, coiled tubing may be utilized to deploy one or more tools into a borehole. As yet another example, wireline may be utilized to deploy one or more tools into a borehole. In various instances, a fiber optics cable may be deployed in a borehole, optionally carried by one or more other components.

As to a drillstring, it can include a bottomhole assembly (BHA) that includes a drill bit that can be rotated to crush rock where drilling fluid may lubricate the drill bit and carry away rock cuttings. As to coiled tubing, it can be a long, continuous length of pipe wound on a spool where the pipe may be straightened prior to pushing into a borehole and rewound to coil the pipe back onto the transport and storage spool. A diameter of coiled tubing (e.g., coiled tubing pipe) may range from approximately 2.5 cm to approximately 10 cm with a length of 50 meters or more. As to wireline, it can relate logging that employs an electrical cable to lower one or more tools into a borehole and to transmit data. Wireline can also be a general term used to describe well-intervention operations conducted using single-strand or multistrand wire or cable for intervention in oil or gas wells. Although applied inconsistently, the term commonly is used in association with electric logging and cables incorporating electrical conductors. Similarly, the term slickline is commonly used to differentiate operations performed with single-strand wire or braided lines.

As to fiber optics cables they may be utilized for one or more types of services that involve position a fiber optics cable in a borehole to acquire downhole data. As an example, distributed temperature sensing (DTS) can use a fiber optics cable to record a change in temperature along a borehole. Distributed temperature can be measured by sending a pulse of laser light down the fiber optics cable. In such an example, molecular vibration, which is directly related to temperature, can create weak reflected signals. These signals can be detected at the surface and converted to a log of temperature along the borehole, for example, sampled approximately every 1 m with a resolution of 0.1 degree C. As an example, a fiber optics cable may be installed at the time of well completion, so that the distributed temperature log can be recorded at one or more later times without well intervention. As an example, a DTS can provide for measuring flow rates by creating a temperature transient and observing its movement along the well.

While DTS is mentioned as an example, a fiber optics cable may be utilized for one or more of distributed acoustic sensing (DAS), distributed strain sensing (DSS), and optical telemetry.

DTS and distributed pressure measurements over extended intervals can help to identify the source of changes in well performance as they occur, enabling accurate diagnostics on gas lift systems; helping to monitor completion integrity; and quickly identifying a faulty valve, unstable flow, inflow, and outflow without interrupting production. DAS technology can measure vibrations, enabling detection of seismic events and small flow changes that may be difficult to capture with conventional DTS technology. DAS data can help to calibrate inflow profiling and can distinguish, for example, gas or solids (sand) from liquid flow. As an example, one or more fiber optics cable-based techniques may be utilized during hydraulic fracturing operations, during one or more other stimulation operations to acquire data, and/or during one or more artificial lift operations.

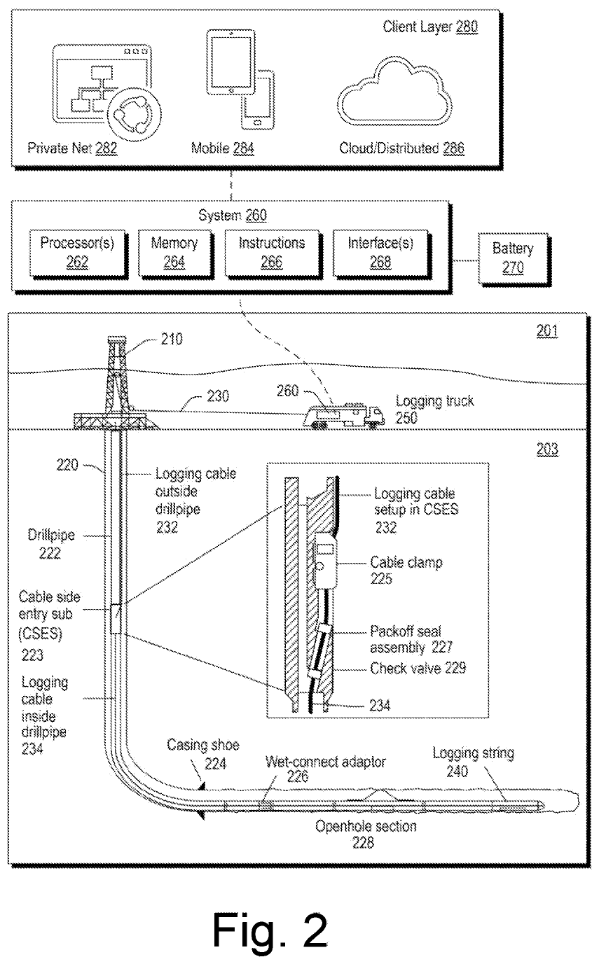

FIG. 2 shows an example of an environment 201 that includes a subterranean portion 203 where a rig 210 is positioned at a surface location above a bore 220. In the example of FIG. 2, various services equipment can be operated to perform one or more services including, for example, acquisition of data from one or more positions within the bore 220. In the example of FIG. 2, a wireline service is illustrated; noting that one or more features shown in FIG. 2 may be utilized for one or more other types of services. For example, features of an equipment architecture shown in FIG. 2 may be utilized for drillstring, coiled tubing, wireline, fiber optics cables, etc.

As an example, a wireline tool and/or a wireline service may provide for acquisition of data, analysis of data, data-based determinations, data-based decision making, etc. Some examples of wireline data can include gamma ray (GR), spontaneous potential (SP), caliper (CALI), shallow resistivity (LLS and ILD), deep resistivity (LLD and ILD), density (RHOB), neutron porosity (BPHI or TNPH or NPHI), sonic (DT), photoelectric (PEF), permittivity and conductivity.

In the example of FIG. 2, the bore 220 includes drillpipe 222, a casing shoe 224, a cable side entry sub (CSES) 223, a wet-connector adaptor 226 and an openhole section 228. As an example, the bore 220 can be a vertical bore or a deviated bore where one or more portions of the bore may be vertical and one or more portions of the bore may be deviated, including substantially horizontal.

In the example of FIG. 2, the CSES 223 includes a cable clamp 225, a packoff seal assembly 227 and a check valve 229. These components can provide for insertion of a logging cable 230 that includes a portion 232 that runs outside the drillpipe 222 to be inserted into the drillpipe 222 such that at least a portion 234 of the logging cable runs inside the drillpipe 222. In the example of FIG. 2, the logging cable 230 runs past the casing shoe 224 and the wet-connect adaptor 226 and into the openhole section 228 to a logging string 240.

As shown in the example of FIG. 2, a logging truck 250 (e.g., a wirelines services vehicle) can deploy the wireline 230 under control of a system 260. As shown in the example of FIG. 2, the system 260 can include one or more processors 262, memory 264 operatively coupled to at least one of the one or more processors 262, instructions 266 that can be, for example, stored in the memory 264, and one or more interfaces 268. As an example, the system 260 can include one or more processor-readable media that include processor-executable instructions executable by at least one of the one or more processors 262 to cause the system 260 to control one or more aspects of equipment of the logging string 240 and/or the logging truck 250. In such an example, the memory 264 can be or include the one or more processor-readable media where the processor-executable instructions can be or include instructions. As an example, a processor-readable medium can be a computer-readable storage medium that is not a signal and that is not a carrier wave.

FIG. 2 also shows a battery 270 that may be operatively coupled to the system 260, for example, to power the system 260. As an example, the battery 270 may be a back-up battery that operates when another power supply is unavailable for powering the system 260 (e.g., via a generator of the wirelines truck 250, a separate generator, a power line, etc.). As an example, the battery 270 may be operatively coupled to a network, which may be a cloud network. As an example, the battery 270 can include smart battery circuitry and may be operatively coupled to one or more pieces of equipment via a SMBus or other type of bus.

As an example, the system 260 can be operatively coupled to a client layer 280. In the example of FIG. 2, the client layer 280 can include features that allow for access and interactions via one or more private networks 282, one or more mobile platforms and/or mobile networks 284 and via the “cloud” 286, which may be considered to include distributed equipment that forms a network such as a network of networks. As an example, the system 260 can include circuitry to establish a plurality of connections (e.g., sessions). As an example, connections may be via one or more types of networks. As an example, connections may be client-server types of connections where the system 260 operates as a server in a client-server architecture. For example, clients may log-in to the system 260 where multiple clients may be handled, optionally simultaneously.

While the example of FIG. 2 shows the system 260 as being associated with the logging truck 250, one or more features of the system 260 may be included in a downhole assembly, which may be a wireline assembly, a drillstring assembly, a coiled tubing assembly, a fiber optics cable assembly, etc. In such an approach, various types of data may be acquired downhole where the data may be optionally stored in a tool downhole and/or transmitted to surface (e.g., to the logging truck 250, etc.) using one or more telemetric technologies and/or techniques (e.g., mud-pulse telemetry, wireline, fiber optics, etc.).

As explained, various types of equipment may be deployed in a borehole where the borehole may be cased, open, etc. As equipment is deployed, contact may occur with its surroundings (e.g., casing, rock, fluid, etc.). As an example, a tool can include carbon nanotubules (CNTs) as a reinforcement coating. For example, consider a fiber optics cable with CNT reinforcement for protection, at least in part, during downhole conveyance. Such an approach can help to improve H2S corrosion resistance, help to reduce hydrogen embrittlement, improve galling resistance, and reduce friction force applied on a cable during running in hole (RIH) and/or pulling out-of-hole (POOH).

In graphene, carbon atoms may be arranged in a hexagonal manner, due to sp2 bonding, as a crystalline allotrope of carbon (e.g., as a large aromatic molecule). Graphene may be described as being a one-atom thick layer of graphite and may be a basic structural element of carbon allotropes such as, for example, graphite, charcoal, carbon nanotubes and fullerenes. Graphene can be characterized as a zero-overlap semimetal (with both holes and electrons as charge carriers) with very high electrical conductivity. Carbon atoms have a total of 6 electrons; 2 in the inner shell and 4 in the outer shell. The 4 outer shell electrons in an individual carbon atom can be available for chemical bonding, but in graphene, each atom is connected to 3 other carbon atoms on the two dimensional plane, leaving 1 electron freely available in the third dimension for electronic conduction.

These highly-mobile electrons are called pi (TT) electrons and are located above and below a graphene sheet. These pi orbitals overlap and help to enhance the carbon to carbon bonds in graphene. Fundamentally, the electronic properties of graphene are dictated by the bonding and anti-bonding (the valance and conduction bands) of these pi orbitals.

A carbon nanotube or carbon nanotubule (CNT) can be defined as a tube made of carbon with diameters typically measured in nanometers. Single-wall carbon nanotubes (SWCNTs) are one of the allotropes of carbon, intermediate between fullerene cages and flat graphene, with diameters in the range of a nanometer. Although not made this way, single-wall carbon nanotubes can be idealized as cutouts from a two-dimensional hexagonal lattice of carbon atoms rolled up along one of the Bravais lattice vectors of the hexagonal lattice to form a hollow cylinder. In this construction, periodic boundary conditions are imposed over the length of this roll-up vector to yield a helical lattice of seamlessly bonded carbon atoms on the cylinder surface. Multi-wall carbon nanotubes (MWCNTs) can be defined as structures consisting of nested single-wall carbon nanotubes weakly bound together by van der Waals interactions in a tree ring-like structure. Multi-wall carbon nanotubes are also sometimes used to refer to double-and triple-wall carbon nanotubes. As an example, carbon nanotubes can refer to tubes with an undetermined carbon-wall structure and diameters less than 100 nanometers.

One type of CNT is referred to as a cup-shaped CNT (CSCNT), which can be a straight long carbon nanofiber having a hollow core that is formed by stacking of smaller CNT structures, for example, one above the other. CSCNTs are known to exhibit a semi-conducting nature due to the stacked microstructure of graphene layers. This kind of CNT formation can find use in the field of nanoelectronics owing to the electronic properties and band gap of 0.44 ev exhibited due to the stacked structure.

As explained, fiber optics cable has been used as a sensor medium in downhole applications. Some types of measurements can include DTS, DAS, DSS, optical telemetry, etc. In various instances, the fiber optic itself cannot be exposed directly to the downhole formation environment as such exposure would likely degrade characteristics of the fiber optic and hence performance. One particular issue is hydrogen ingression, which causes a fiber darkening effect, where the fiber attenuation increases substantially resulting usability for fiber optics measurements.

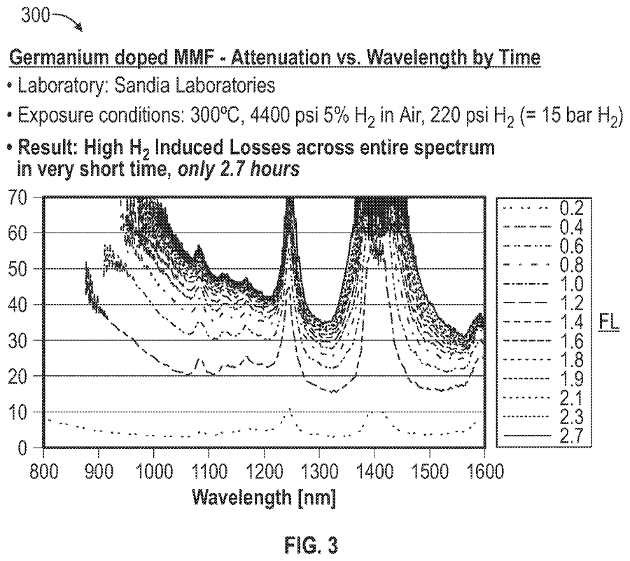

FIG. 3 shows an example plot 300 of results from a study of hydrogen-induced issues. Hydrogen-induced increases in the attenuation of installed fibers have been studied for decades (e.g., since at least 1983). The plot 300 shows that exposing fiber optics to high H2 concentration will result high increase of fiber attenuation performance in a very short period. Hence protection of a fiber optics cable can be beneficial for downhole applications.

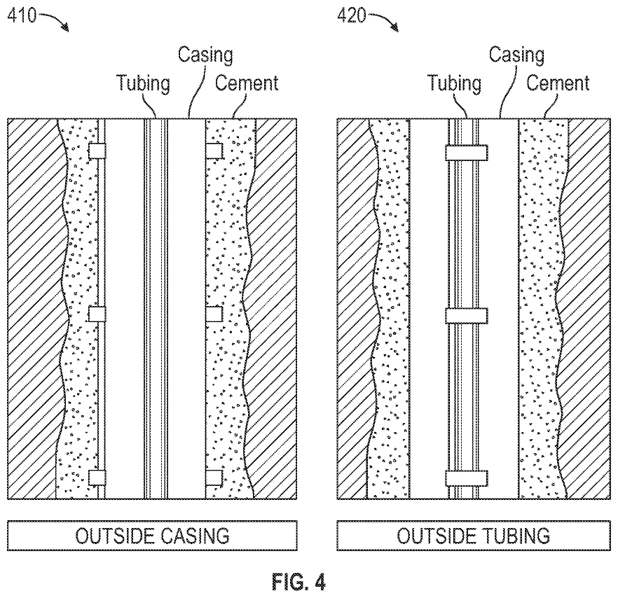

FIG. 4 shows example graphics 410 and 420 of fiber optics cables deployed outside of casing and outside of tubing, respectively. As shown, the casing can be cemented into a borehole where cement is presented between an outer surface of the casing and the wall of the borehole (e.g., a borehole wall formed by formation rock). In the example of the graphic 420, the fiber optics cable can be disposed between an outer surface of the tubing and an inner surface of the casing, where, for example, it may be exposed to one or more types of fluids (e.g., gas, liquid, etc.) and possibly one or more types of solids.

In the graphic 410, the sensor cable is behind casing (e.g., outside of casing) where it may be permanently clamped outside of a cemented casing. In such a configuration, the cable may be directly exposed to reservoir formation.

In the graphic 420, the sensor cable can be semi-permanent (e.g., outside of tubing). In such an example, the cable can be clamped outside of a production tubing inside a casing. In such an example, the cable may not be directly exposed to reservoir formation.

As to some examples of applications, consider real-time logging which may employ wireline logging, coiled tubing, and/or slickline intervention. As an example, a downhole cable may be deployed into a wellbore for logging measurement using one or more conveyance techniques such as wireline, coiled tubing and/or slickline. In various instances, the cable is retrieved from the wellbore after the job is completed. As to monitoring for hydraulic fracturing, DTS and DAS may be employed to monitor the effectiveness of hydraulic fracturing performance (e.g., flows, temperatures, vibrations, perforations, microseismic emissions, etc.). As explained, installation of a cable can be for permanent monitoring (see, e.g., the graphic 410) or for semi-permanent (see, e.g., the graphic 420).

As an example, applications can be coded as Type I (permanent), Type II (semi-permanent), Type III (real-time logging), and Type IV (stimulation), noting that some cross-over may exist between types (e.g., Type IV may utilize one or more other types).

A most common protection approach is to install fiber optics cable inside a metal tube for downhole applications. For example, consider tubing encapsulated cable (TEC), which may be used in Type I, II and III applications. As to metal-in-metal tubes for downhole cable, such an approach may be used in Type Il and Type IV applications.

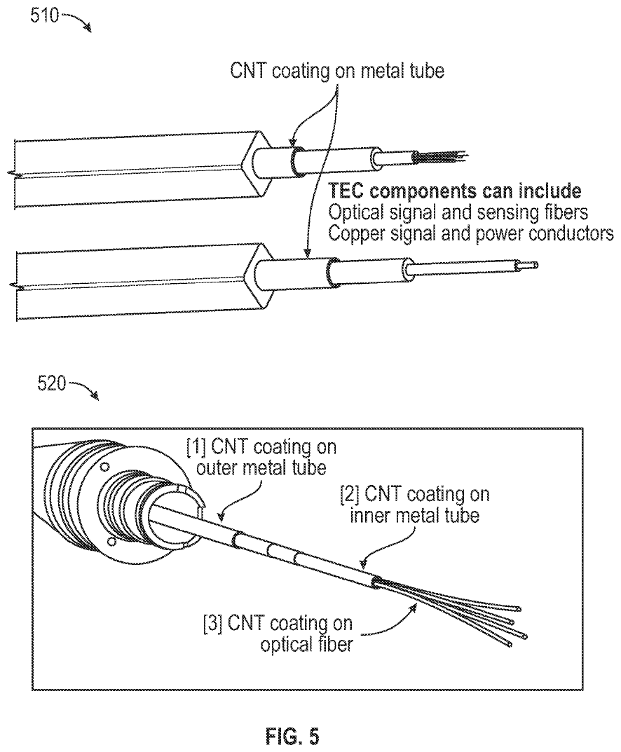

FIG. 5 shows examples of optics fiber components and assemblies 510 and 520 suitable for downhole deployment and use in sensing and/or transmission of data, commands, etc. The example assemblies 510 include CNT coated metal tubes and the example assemblies 520 include CNT coating on an outer metal tube, a CNT coating on an inner metal tube and/or a CNT coating on optics fibers (e.g., optical fibers).

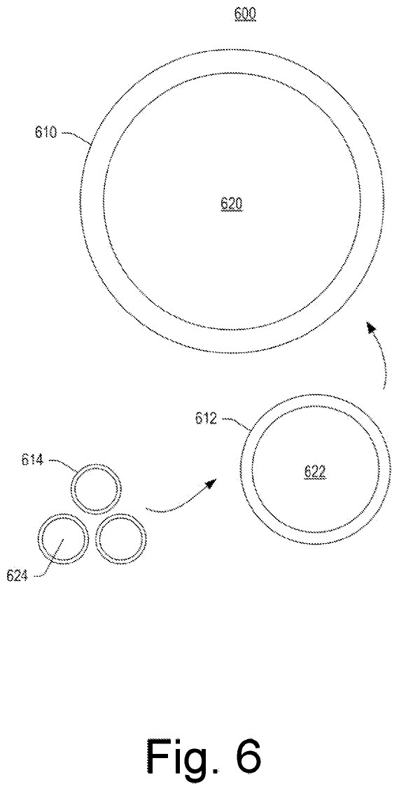

FIG. 6 shows an example system 600 that can include CNT coatings 610, 612 and 614 on various components 620, 622 and 624, which may be nested in an assembly. For example, the components 624 can be optics fibers, the component 622 can be a tube with a bore for the components 624 and the component 620 can be a tube with a bore for one or more instances of the component 622; noting that while three optics fibers are illustrated, fewer or more optics fibers may be included in the system 600.

As explained, a method can include applying a CNT coating on an outer surface of a metallic tube (e.g., metal or alloy) for one or more purposes, which can include one or more of improving H2S corrosion resistance, reducing risk of hydrogen embrittlement, improving galling resistance and reducing friction force applied on a cable during RIH and/or POOH operations.

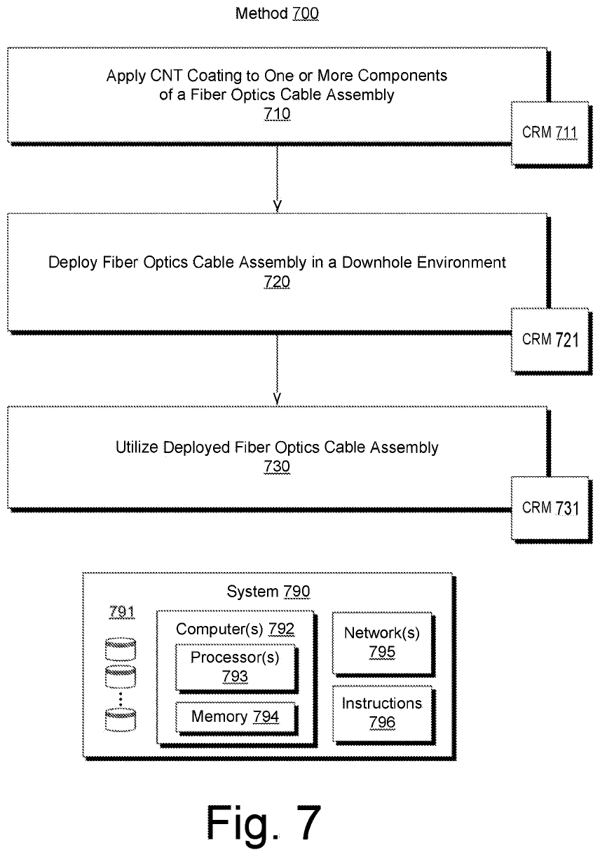

FIG. 7 shows an example of a method 700 and an example of a system 790. As shown, the method 700 can include an application block 710 for applying a CNT coating to one or more components of a fiber optics cable assembly, a deployment block 720 for deploying the fiber optics cable assembly in a downhole environment, and a utilization block 730 for utilizing the fiber optics cable assembly in the downhole environment.

The method 700 is shown in FIG. 7 in association with various computer-readable media (CRM) blocks 711, 721 and 731. Such blocks generally include instructions suitable for execution by one or more processors (or processor cores) to instruct a computing device or system to perform one or more actions.

While various blocks are shown, a single medium may be configured with instructions to allow for, at least in part, performance of various actions of the method 700. As an example, a computer-readable medium (CRM) may be a computer-readable storage medium that is non-transitory and that is not a carrier wave. As an example, one or more of the blocks 711, 721 and 731 may be in the form processor-executable instructions.

In the example of FIG. 7, the system 790 includes one or more information storage devices 791, one or more computers 792, one or more networks 795 and instructions 796. As to the one or more computers 792, each computer may include one or more processors (e.g., or processing cores) 793 and memory 794 for storing the instructions 796, for example, executable by at least one of the one or more processors 793 (see, e.g., the blocks 711, 721 and 731). As an example, a computer may include one or more network interfaces (e.g., wired or wireless), one or more graphics cards, a display interface (e.g., wired or wireless), etc.

As an example, a method can include applying a carbon nanotubule coating to one or more components of a fiber optics cable assembly; deploying the fiber optics cable assembly in a downhole environment; and utilizing the fiber optics cable assembly in the downhole environment. In such an example, the applying can apply the carbon nanotubule coating to a metallic tube of the fiber optics cable assembly. As an example, applying can apply a carbon nanotubule coating to an outermost surface of a fiber optics cable assembly.

As an example, a method can include utilizing a fiber optics cable assembly for performing one or more of distributed temperature sensing, distributed acoustic sensing and distributed strain sensing.

As an example, a method can include utilizing a fiber optics cable assembly for performing optical telemetry, optionally in combination with one or more types of sensing.

As an example, a method can include deploying the fiber optics cable assembly comprises one or more of performing wireline deployment, tubing deployment and casing deployment. In such an example, tubing deployment may include coiled tubing deployment.

As an example, a method can include exposing a fiber optics cable assembly to one or more downhole fluids.

As an example, one or more carbon nanotubule coatings of a fiber optics cable assembly can improve H2S corrosion resistance, reduce risk of hydrogen embrittlement, improve galling resistance and/or reduce friction force applied on a cable during RIH and/or POOH operations.

As an example, a fiber optics cable assembly can include components, where the components include at least one optical fiber; and one or more carbon nanotubule coatings disposed on at least one of the components. In such an example, at least one of the at least one optical fiber can include at least one of the one or more carbon nanotubule coatings.

As an example, a fiber optics cable assembly can include components that include a metallic tube where, for example, the metallic tube includes one or more carbon nanotubule coatings.

As an example, a fiber optics cable assembly can include a component that is an outermost component that includes a carbon nanotubule coating.

As an example, a fiber optics cable assembly can include at least one optical fiber that is a sensing fiber. As an example, a fiber optics cable assembly can include at least one optical fiber that is a telemetry fiber. As an example, a fiber optics cable assembly can include at least one optical fiber that is a sensing fiber and at least one optical fiber that is a telemetry fiber.

As an example, a fiber optics cable assembly can have a length of more than 100 meters and/or a diameter less than 10 cm and greater than 0.1 cm.

As an example, a computer program product can include one or more computer-readable storage media that can include processor-executable instructions to instruct a computing system to perform one or more methods and/or one or more portions of a method.

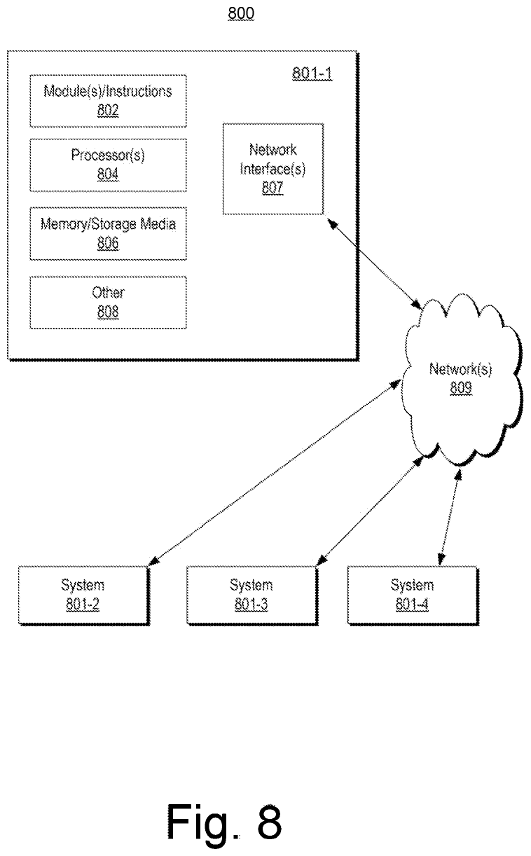

In some embodiments, a method or methods may be executed by a computing system. FIG. 8 shows an example of a system 800 that can include one or more computing systems 801-1, 801-2, 801-3 and 801-4, which may be operatively coupled via one or more networks 809, which may include wired and/or wireless networks.

As an example, a system can include an individual computer system or an arrangement of distributed computer systems. In the example of FIG. 8, the computer system 801-1 can include one or more modules 802, which may be or include processor-executable instructions, for example, executable to perform various tasks (e.g., receiving information, requesting information, processing information, simulation, outputting information, etc.).

As an example, a module may be executed independently, or in coordination with, one or more processors 804, which is (or are) operatively coupled to one or more storage media 806 (e.g., via wire, wirelessly, etc.). As an example, one or more of the one or more processors 804 can be operatively coupled to at least one of one or more network interfaces 807; noting that one or more other components 808 may also be included. In such an example, the computer system 801-1 can transmit and/or receive information, for example, via the one or more networks 809 (e.g., consider one or more of the Internet, a private network, a cellular network, a satellite network, etc.).

As an example, the computer system 801-1 may receive from and/or transmit information to one or more other devices, which may be or include, for example, one or more of the computer systems 801-2, etc. A device may be located in a physical location that differs from that of the computer system 801-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 806 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution. As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
applying a carbon nanotubule coating to one or more components of a fiber optics cable assembly;
deploying the fiber optics cable assembly in a downhole environment; and
utilizing the fiber optics cable assembly in the downhole environment.

2. The method of claim 1, wherein the applying applies the carbon nanotubule coating to a metallic tube of the fiber optics cable assembly.

3. The method of claim 1, wherein the applying applies the carbon nanotubule coating to an outermost surface of the fiber optics cable assembly.

4. The method of claim 1, wherein the utilizing the fiber optics cable assembly comprises performing one or more of distributed temperature sensing, distributed acoustic sensing and distributed strain sensing.

5. The method of claim 1, wherein the utilizing the fiber optics cable assembly comprises performing optical telemetry.

6. The method of claim 1, wherein the deploying the fiber optics cable assembly comprises one or more of performing wireline deployment, tubing deployment and casing deployment.

7. The method of claim 6, wherein the tubing deployment comprises coiled tubing deployment.

8. The method of claim 1, comprising exposing the fiber optics cable assembly to one or more downhole fluids.

9. The method of claim 1, wherein the carbon nanotubule coating improves H2S corrosion resistance, reduces risk of hydrogen embrittlement, improves galling resistance and/or reduces friction force applied on a cable during RIH and/or POOH operations.

10. A fiber optics cable assembly comprising:
components, wherein the components comprise at least one optical fiber; and
one or more carbon nanotubule coatings disposed on at least one of the components.

11. The fiber optics cable assembly of claim 10, wherein at least one of the at least one optical fiber comprises at least one of the one or more carbon nanotubule coatings.

12. The fiber optics cable assembly of claim 10, wherein the components comprise a metallic tube.

13. The fiber optics cable assembly of claim 12, wherein the metallic tube comprises one of the one or more carbon nanotubule coatings.

14. The fiber optics cable assembly of claim 10, wherein one of the components is an outermost component that comprises one of the one or more carbon nanotubule coatings.

15. The fiber optics cable assembly of claim 10, wherein the at least one optical fiber comprises a sensing fiber.

16. The fiber optics cable assembly of claim 10, wherein the at least one optical fiber comprises a telemetry fiber.

17. The fiber optics cable assembly of claim 10, comprising a length of more than 100 meters.

18. The fiber optics cable assembly of claim 10, comprising a diameter less than 10 cm and greater than 0.1 cm.
